(19) United States
(12) Patent Application Publication
(10) Pub. No.: US 2012/0127923 A1
(43) Pub. Date: May 24, 2012

(54) Method and Apparatus for Enabling a Low Complexity Receiver

(76) Inventors: Wanlun Zhao, San Diego, CA (US); Peter John Black, San Diego, CA (US); Jinghu Chen, San Diego, CA (US)

(21) Appl. No.: 12/952,737

(22) Filed: Nov. 23, 2010

(51) Int. Cl. H04W 4/00

(52) U.S. Cl. 370/328

(57) ABSTRACT

A method and apparatus for enabling a low complexity DL receiver in a TD-SCDMA system is provided. The method may comprise receiving two or more signals from two or more cells, determining at least one of the two or more cells does not comprise colored noise, applying a white noise matrix approximation to each of the at least one of the two or more cells that does not comprise colored noise, applying a channel matrix approximation to the two or more received signals, and generating a MMSE coordination matrix using the white noise matrix approximation and the channel matrix approximation.

### BACKGROUND

1. Field

Aspects of the present disclosure relate generally to wireless communication systems, and more particularly, for enabling a low complexity downlink (DL) receiver in a system, such as a time division synchronous code division multiple access (TD-SCDMA).

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UTMS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and TD-SCDMA. For example, China is pursuing TD-SCDMA as the underlying air interface in the UTRAN architecture with its existing GSM infrastructure as the core network. The UMTS also supports enhanced 3G data communications protocols, such as High Speed Downlink Packet Data (HSDPA), which provides higher data transfer speeds and capacity to associated UMTS networks.

As the demand for mobile broadband access continues to increase, research and development continue to advance the UMTS technologies not only to meet the growing demand for mobile broadband access, but to advance and enhance the user experience with mobile communications.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In accordance with one or more aspects and corresponding disclosure thereof, various aspects are described in connection enabling a low complexity DL receiver in a TD-SCDMA system. The method can comprise receiving two or more signals from two or more cells, determining at least one of the two or more cells does not comprise colored noise, applying a white noise matrix approximation to each of the at least one of the two or more cells that does not comprise colored noise, applying a channel matrix approximation to the two or more received signals, and generating a MMSE coordination matrix using the white noise matrix approximation and the channel matrix approximation.

Yet another aspect relates to an apparatus. The apparatus can include means for receiving two or more signals from two or more cells, means for determining at least one of the two or more cells does not comprise colored noise, means for applying a white noise matrix approximation to each of the at least one of the two or more cells that does not comprise colored noise, means for applying a channel matrix approximation to the two or more received signals, and means for generating a MMSE coordination matrix using the white noise matrix approximation and the channel matrix approximation.

Still another aspect relates to a computer program product comprising a computer-readable medium. The computer-readable medium can include code for receiving two or more signals from two or more cells, determining at least one of the two or more cells does not comprise colored noise, applying a white noise matrix approximation to each of the at least one of the two or more cells that does not comprise colored noise, applying a channel matrix approximation to the two or more received signals, and generating a MMSE coordination matrix using the white noise matrix approximation and the channel matrix approximation.

Another aspect relates to an apparatus for wireless communications. The apparatus can include a receiver configured to receive two or more signals from two or more cells. The apparatus may also include at least one processor configured to determine at least one of the two or more cells does not comprise colored noise, apply a white noise matrix approximation to each of the at least one of the two or more cells that does not comprise colored noise, apply a channel matrix approximation to the two or more received signals, and generate a MMSE coordination matrix using the white noise matrix approximation and the channel matrix approximation.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a Node B in communication with a user equipment (UE) in a telecommunications system.

FIG. 4 is a functional block diagram conceptually illustrating example blocks executed to implement the functional characteristics of one aspect of the present disclosure.

FIG. 5 is a diagram conceptually illustrating an exemplary TD-SCDMA based system with multiple UEs communicating with a node B as time progresses in an aspect of the present disclosure.

FIG. 6 is a diagram conceptually illustrating an example wireless communications system in an aspect of the present disclosure.

FIG. 7 is a block diagram of an exemplary wireless communications device configured to enable a low complexity receiver according to an aspect.

FIG. 8 is a diagram conceptually illustrating multiple cumulative distribution function (CDF) graphs of one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Generally, a UE may receive signals from multiple cells. For example, for TD-SCDMA downlink with a single receive antenna, a serving cell signal may be interfered with by near white noise and/or by another dominating cell and white noise. As such, systems and methods for processing received signals using a low complexity receiver are disclosed herein.

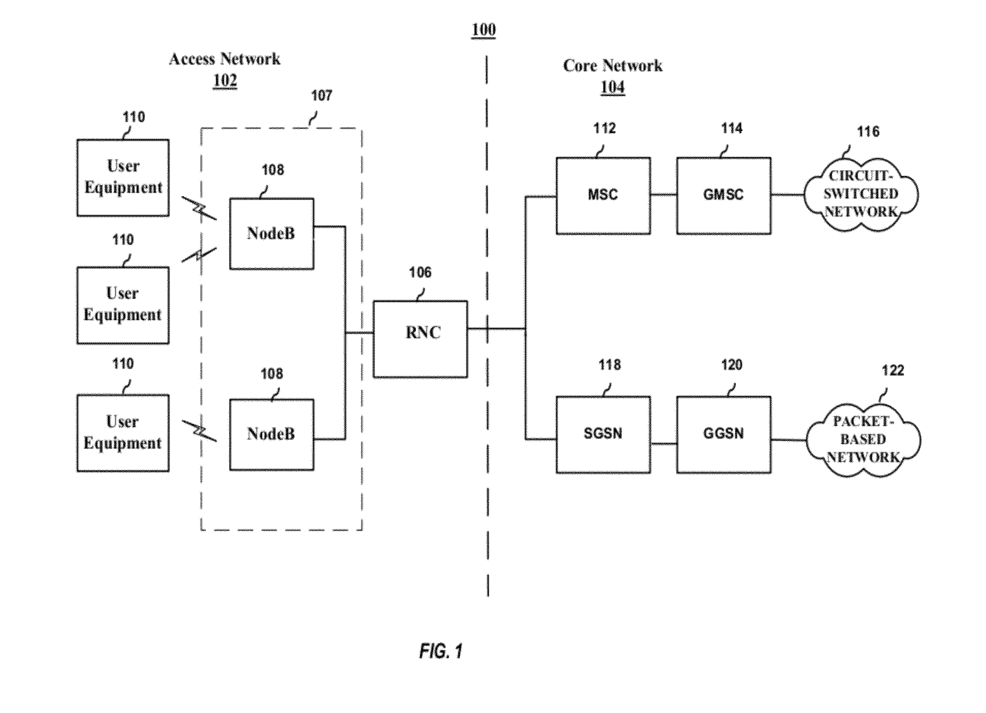

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of Radio Network Subsystems (RNSs) such as an RNS 107, each controlled by a Radio Network Controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two Node Bs 108 are shown; however, the RNS 107 may include any number of wireless Node Bs. The Node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as UE in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the Node Bs 108. The downlink (DL), also called the forward link, refers to the communication link from a Node B to a UE, and the uplink (UL), also called the reverse link, refers to the communication link from a UE to a Node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving GPRS support node (SGSN) 118 and a gateway GPRS support node (GGSN) 120. GPRS, which stands for General Packet Radio Service, is designed to provide packet-data services at speeds higher than, those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a Node B 108 and a UE 110, but divides uplink and downlink transmissions into different time slots in the carrier.

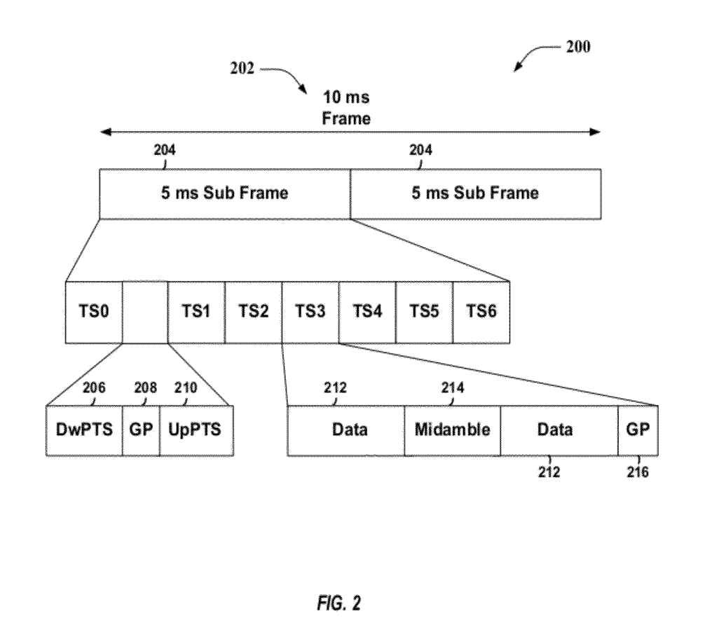

FIG. 2 shows a frame structure 200 for a TD-SCDMA carrier. The TD-SCDMA carrier, as illustrated, has a frame 202 that is 10 ms in length. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 separated by a midamble 214 and followed by a guard period (GP) 216. The midamble 214 may be used for features, such as channel estimation, while the GP 216 may be used to avoid inter-burst interference.

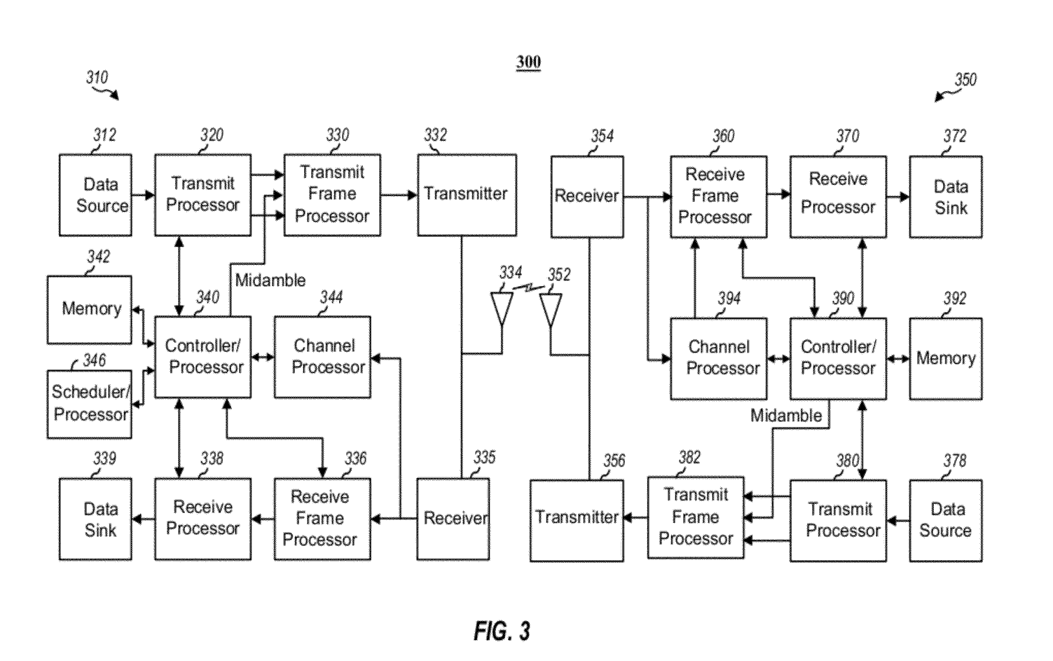

FIG. 3 is a block diagram of a Node B 310 in communication with a UE 350 in a RAN 300, where the RAN 300 may be the RAN 102 in FIG. 1, the Node B 310 may be the Node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shill keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the Node B 310. More specifically, the receive processor 370 descrambles and despreads the symbols, and then determines the most likely signal constellation points transmitted by the Node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receiver processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the Node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the Node B 310 or from feedback contained in the midamble transmitted by the Node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the Node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the Node B 310 and the UE 350, respectively. For example, the controller/processors 340 and 390 may provide various functions including timing, peripheral interfaces, voltage regulation, power management, and other control functions. The computer readable media of memories 342 and 392 may store data and software for the Node B 310 and the UE 350, respectively. A scheduler/processor 346 at the Node B 310 may be used to allocate resources to the UEs and schedule downlink and/or uplink transmissions for the UEs.

In one aspect, controller/processors 340 and 390 may enable enhanced FDE. In one configuration, the apparatus 350 for wireless communication includes means for receiving two or more signals from two or more cells, means for determining at least one of the two or more cells does not comprise colored noise, means for applying a white noise matrix approximation to each of the at least one of the two or more cells that does not comprise colored noise, means for applying a channel matrix approximation to the two or more received signals, and means for generating a MMSE coordination matrix using the white noise matrix approximation and the channel matrix approximation. In one aspect, the means for receiving may include receiver 354. In another aspect, the means for converting, inverting and determining may include controller/processor 390. In another configuration, the apparatus 350 includes means determining one or more MMSE signals by applying the MMSE coordination matrix to the received two or more signals. In another configuration, the apparatus 350 includes means for determining an inverse coordination matrix by inverting the MMSE coordination matrix, and means for applying the inverse coordination matrix to the received two or more signals. In another configuration, the apparatus 350 includes means for inverting the MMSE coordination matrix using iterative processing. In another configuration, the apparatus 350 includes means for determining that all of the two or more cells comprise colored noise, and means for indicating a serving cell of the two or more cells does not comprise colored noise. In another configuration, the apparatus 350 includes means for substituting an identity matrix for a power gain matrix for each of the at least one of the two or more cells that does not comprise colored noise.

In one aspect, the aforementioned means may be the processor(s) 360, 380 and/or 390 configured to perform the functions recited by the aforementioned means. In another aspect, the aforementioned means may be a module or any apparatus configured to perform the functions recited by the aforementioned means.

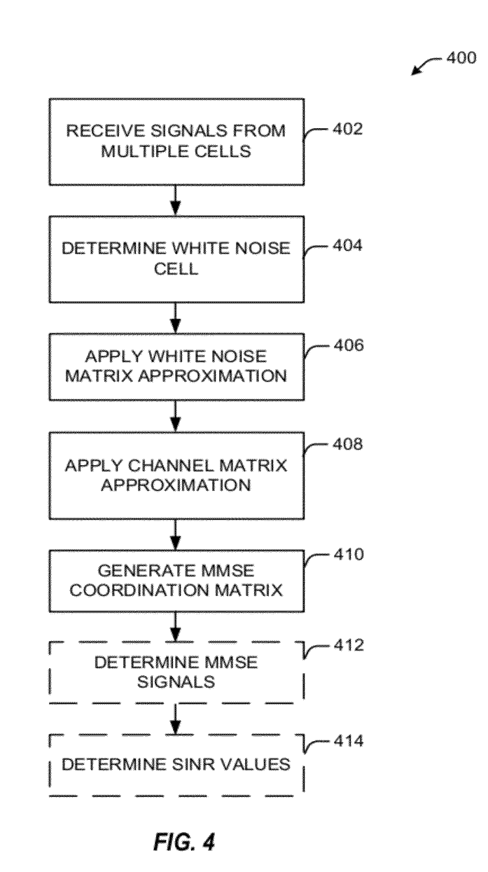

FIG. 4 illustrates various methodologies in accordance with various aspects of the presented subject matter. While, for purposes of simplicity of explanation, the methodologies are shown and described as a series of acts or sequence steps, it is to be understood and appreciated that the claimed subject matter is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the claimed subject matter. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

FIG. 4 is a functional block diagram 400 illustrating example blocks executed in conducting wireless communication according to one aspect of the present disclosure.

In block 402, a UE may receive two or more streams from two or more cells. In one aspect, a transmitted chip block from one of the cells (cell i) may be expressed in equation (1).

$${x}_{i} = [ \begin{matrix}{x}_{i , 1} \\ {x}_{i , 2} \\ ⋮ \\ {x}_{i , N}\end{matrix} ] \qquad ( 1 )$$

In such a chip block set, each smaller vector (xᵢⱼ) may have dimensions 16×1 and may be generated using equation (2).

xᵢⱼ=CᵢWGᵢs_{i,j} (2)

Where Cᵢ is a 16×16 diagonal scrambling matrix, W is 16×16 Walsh matrix, and the power gain matrix Gᵢ is also 16×16 diagonal and s_{i,j} is a 16×1 vector. Entries of s_{i,j} may be drawn from certain constellations such as quadrature phase-shift keying (QPSK). In one aspect, where not all Walsh channels are active, the corresponding diagonal entries of Gᵢ may be set to 0. Further, in one aspect, transmissions through a multipath channel may be modeled by multiplying xᵢ with a Toeplitz channel matrix, as described in equation (3).

y=H₀x₀+H₁x₁+v (3)

Where channel matrices (H) may have dimension (16N=L)×(16N), as expressed in equation (4).

$${H}_{i} = [ \begin{matrix}{h}_{i , 0} & & & \\ {h}_{i , 1} & {h}_{i , 0} & & \\ ⋮ & {h}_{i , 1} & ⋱ & {h}_{i , 0} \\ {h}_{i , L} & ⋮ & ⋱ & {h}_{i , 1} \\ & {h}_{i , L} & ⋱ & ⋮ \\ & & & {h}_{i , L}\end{matrix} ] \qquad ( 4 )$$

Hᵢ may have L+1 taps with coefficients h_{i,0} to h_{i,L}. Further, in one aspect, Hᵢ may be assumed to be a circulant approximation, and with a proper FFT block size, the approximation may incur negligible degradations on performance. As such, using a FFT/IFFT operation equation (3) may be manipulated to result in equation (5).

F_{y}=FH₀F^{H}Fx₀+FH₁F^{H}Fx₁+Fv [symbol] r=D₀Fx₀D₁Fx₁+u (5)

Where D₀ and D₁ are the diagonalized channel matrix in the frequency domain and u=Fv may have the same statistics as v˜CN(0, σ²I).

Generally, for a linear MMSE receiver, a coordination matrix Rᵣᵣ may be used. The exact coordination matrix may be expressed in equation (6).

Rᵣᵣ=D₀F(I_{N} [symbol] A₀)F^{H}D₀^{H}+D₁F(I_{N} [symbol] A₁)F^{H}D₁^{H}+σ²I (6)

Where matrix Aᵢ may be defined in equation (7).

Aᵢ=CᵢWGᵢ²W^{T}Cᵢ^{H} (7)

In one aspect, when the power gain matrix Gᵢ is identity, Aᵢ may be reduced to an identity matrix for any deterministic or pseudo-random Cᵢ.

In block 404, a cell may be determined to have white noise. Generally, inverting the exact Rᵣᵣ may be computationally complex. In one aspect, to reduce complexity of matrix inversions, at least one of the signals received from the cells signal may be determined to be white in Walsh domain. That is, in an aspect with two cells, either G₀=I or G₁=I. In one aspect, where both Gᵢ are colored in the Walsh domain, it may be determined that a signal received from a serving cell is white (e.g., G₀=I). In another aspect, most Walsh codes in a time slot in TDS-HSDPA DL may be assigned to a single user, and as such signal may be close to white.

In block 406, the white noise approximation may be applied to equation (6) results in equation (8).

\tilde{R}ᵣᵣ=D₀D₀^{H}+D₁F(I_{N} [symbol] A₁)F^{H}D₁^{H}+σ²I (8)

In block 408, a channel matrix approximation may be applied. In one aspect, a diagonalized channel matrix (D) may be approximated using equation (9).

D²=D₀D₀^{H}+D₁D₁H+σ²I (9)

Where D² may be a 16N×16N diagonal matrix.

In block 410, a MMSE coordination matrix may be generated using the above discussed approximations. In one aspect, an approximated coordination matrix may be expressed in equation (10).

$${\check{R}}_{rr} = DF \{ \frac{tr ( {D}_{0} {D}_{0}^{H} )}{tr ( {D}^{2} )} I + \frac{tr ( {D}_{1} {D}_{1}^{H} )}{tr ( {D}^{2} )} B + \frac{tr ( {σ}^{2} I )}{tr ( {D}^{2} )} I \} {F}^{H} {D}^{H} \qquad ( 10 )$$

Where matrix B=I_{N} [symbol] A₁ may be block diagonal with N16×16 A₁ matrices on the diagonal. In one aspect, the phase of the complex diagonal matrix D may be set to substantially match phase of D₁. As used herein,

$$\frac{tr ( {D}_{0} {D}_{0}^{H} )}{tr ( {D}^{2} )} , \frac{tr ( {D}_{1} {D}_{1}^{H} )}{tr ( {D}^{2} )} , \frac{tr ( {σ}^{2} I )}{tr ( {D}^{2} )} ,$$

are fractions of serving cell's, interfering cell's, white noise's averaged power in total averaged power, respectively. As such, even though channel selectivity may be separated from Walsh domain structures, the averaged power from each cell may remain intacedt when exploiting Walsh domain properties.

In one aspect, assuming transmissions from two cells, where signal transmissions from both cells are white in Walsh domain, A₁=I, and as such B=I. Substituting these values into equation (10) results in equation (6). In other words, in such an aspect, the approximated coordination matrix is equation to the exact coordination matrix. In another aspect, assuming transmissions from two cells, where channels for both cells are flat fading with coefficients h₀ and h₁, respectively. In such an aspect, equation (9) may be rewritten as equation (11).

D²=(|h₀|²+|h₁|²+σ²)I (11)

In such an aspect, substituting equation (11) into equation (10) results in equation (6). In other words, similarly to above, in such an aspect, the approximated coordination matrix is equation to the exact coordination matrix. It can be observed the above described aspect may represent two cases, where in the first there is no Walsh domain structure and in the second there is no frequency domain structure. Generally, there might be structures in both Walsh and frequency domains. For such aspects, the coordination matrix approximation may become less accurate than the exact coordination matrix formulation. In one aspect, the approximated coordination matrix may be used to separate the effect of frequency selectivity from Walsh domain structures. Further, this separation may enable low complexity inversions of Rᵣᵣ.

Additionally, optionally, or in the alternative, in block 412, one or more MMSE signals may be generated. In one aspect, the MMSE signals may be derived from an inverted coordination matrix. Further, in one aspect, equation (12) expresses the inversion of the approximate coordination matrix, where a and b are scalars.

\check{R}ᵣᵣ⁻¹=D^{H,-1}F(aB+bI)⁻¹F^{H}D⁻¹ (12)

As D is a diagonal matrix, it may be readily inverting using an FFT/IFFT process. Additionally, the (aB+bI) term may be readily invertible, as seen in equation (13) through an expression indicating one of a 16×16 submatrices on the diagonal of (aB+bI).

[aC₁WG₁²W^{T}C₁^{H}bI]C₁W=C₁W(aG₁²bI) (13)

In other words, columns of C₁W are eigenvectors of the 16×16 matrix with the corresponding eigenvalues as diagonal entries of aG₁²+bI. As such, the eigenvectors and eigenvalues may be expressed in equations (14) and (15).

Q=I_{N} [symbol] (C₁W) (14)

A=I_{N} [symbol] (aG₁²+bI) (15)

Looking again at equation (12) in light of equations (13), (14) and (15), one may note that inversion of Rrr involves inverting only diagonal matrixes, and as such, may be computationally straightforward. Generally, a structured Rᵣᵣ matrix allows for low complexity inversion.

In one aspect, with a symbol vector, such as described in equation (16), equation (1) may be expressed as equation (17).

$$\begin{matrix}{s}_{i} = [ \begin{matrix}{s}_{i , 1} \\ {s}_{i , 2} \\ ⋮ \\ {s}_{i , N}\end{matrix} ] & ( 16 ) \\ {x}_{i} = [ {I}_{N} ⊗ ( {C}_{i} {WG}_{i} ) ] {s}_{i} & ( 17 )\end{matrix}$$

As such, in an aspect in which channel values are known and power gain matrix values are knows for a serving cell, a symbol vector estimate for the serving cell may be described in equation (18).

ŝ₀=[I_{N} [symbol] (G₀^{H}W^{H}C₀^{H})]F^{H}D₀^{H}\check{R}ᵣᵣ⁻¹Fy (18)

In one aspect, the value's may be known from previous sampling. In another aspect, the values may be approximated. In an aspect in which values are estimated and a UE is served by multiple Walsh channels, the power gain on channels may be substantially similar. As such, power gain values from equation (18) may be absorbed into channel coefficients, as expressed in equation (19).

ŝ₀=[I_{N} [symbol] (W₀^{H}C₀^{H})]F^{H}\hat{D}₀^{H}\hat{R}ᵣᵣ⁻¹Fy (19)

Where \tilde{R}ᵣᵣ is expressed in equation (20).

$${\check{R}}_{rr} = {{D}^{̑}}^{2} F \{ \frac{tr ( {{D}^{̑}}_{0} {{D}^{̑}}_{0}^{H} )}{tr ( {{D}^{̑}}^{2} )} I + \frac{tr ( {{D}^{̑}}_{1} {{D}^{̑}}_{1}^{H} )}{tr ( {{D}^{̑}}^{2} )} P + \frac{tr ( {{σ}^{̑}}^{2} I )}{tr ( {{D}^{̑}}^{2} )} I \} {F}^{H} \qquad ( 20 )$$

Where P=I_{N} [symbol] (C₁W₁W₁^{T}C₁^{H}). Additionally, the power gain matrix may be expressed in the form Gᵢ=aᵢI. As such, αᵢDᵢ may be determined jointly with channel estimations. Further, Wᵢ may carry information of active Walsh codes from cell i (e.g., columns of Wᵢ may contain active Walsh codes).

Additionally, in one aspect, \tilde{R}ᵣᵣ may be iteratively inverted. In such an aspect, iterative inversion may exploit transmitted cell signal Walsh structure. Further, an iterative inversion approach may involve 2×2 matrix inversions and matrix multiplications. In one aspect, equation (10) may include values A and B which may be block diagonal matrices with 16×16 blocks, as defined in equations (21) and (22). Further, each block may be described in equation (23).

A=I_{N} [symbol] (C₀WG₀²W^{T}C₀^{H}) (21)

B=I_{N} [symbol] (C₁WG₁²W^{T}C₁^{H}) (22)

aC₀WG₀²W^{T}C₀^{H}+bC₁WG₁²W^{T}C₁^{H}+σ²I (23)

In one aspect, σ²I may be combined with the cell 0 power matrix resulting in equation (24).

X=aC₀WG₀²W^{T}C₀^{H}+bC₁WG₁²W^{T}C₁^{H} (24)

Further, the complexity associated with inverting X may depend on the number of active Walsh codes from each cell. (e.g., define the number of active Walsh codes for cell i as Nᵢε[0, 2, 4, 6, 8, 10, 12, 14, 16]). In one aspect, min(N₀, 16-N₀)≧16-N₁):=²Nᵢₜₑᵣ may be assumed. Where Nᵢₜₑᵣ may be used to determine the number of update iterations used for inverting X. Further, in one aspect, first N₁ diagonal entries of G₁ may be 1 and other entries may be 0. In other words, the active Walsh codes from cell 1 may have equal power. Further, where cell 1 serves several users, these users may have different equivalent channels; the cell may be split into several virtual cells each corresponds to one user.

Further, X may be inverted using the iterative process described in equations (25) and (26). Where, if N₁<(16-N₁), X₀ may be expressed in equation (25), and otherwise, X₀ may be expressed in equation (26).

X₀=aC₀WG₀²W^{T}C₀H (25)

X₀=aC₀WG₀²W^{T}C₀^{H}+bC₁WIG₁²W^{T}C₁^{H} (26)

Where the difference between X and X0 may be expressed in equation (27).

bC₁WG₁²W^{T}C₁^{H} or −bC₁W G̅₁²W^{T}C₁^{H} (27)

Where G̅₁² has 0 for the first N₁ diagonal entries and other diagonal entries 1. Further, C₁W may be defined using equation (28).

C₁W:=[C₁w₀C₁w₁C₁w₂C₁w₃ . . . C₁w₁₄C₁w₁₅]:=[u₀u₁ . . . u₇] (28)

In other words, each 16×2 matrix uᵢ corresponds to 2 columns of C₁W and as such, the first inversion iteration may be expressed by equation (29).

X₁=X₀+bu₀u₀^{H} (29)

Generally, the inversion iterations may be expressed by equation (30).

$${X}_{i + 1}^{- 1} = {X}_{i}^{- 1} - ( {X}_{i}^{- 1} {u}_{i} ) \cdot {[ \frac{1}{b} I + {u}_{i}^{H} {X}_{i}^{- 1} {u}_{i} ]}^{- 1} \cdot {( {X}_{i}^{- 1} {u}_{i} )}^{H} \qquad ( 30 )$$

As such, After Nᵢₜₑᵣ iterations, the resulting X_{Niter} becomes the original X matrix and X has been inverted with Nᵢₜₑᵣ iteration steps. In one aspect, inversion may occur in 4 iterations for a two cell system.

In another aspect, the determining whether to use an iterative inversion process may be made using the number of taps each estimated channels has, ad a threshold value. For example, if single taps are received from all cells, the process may use iterative inversion with the LC-FDE otherwise the process may use conversional inversion with the LC-FDE.

Additionally, in on optional aspect, in block 414, SINR values for each Walsh channel may be determined. In one aspect, a transmission vector from a cell may be expressed in equation (31) with the total power being expressed in equation (32).

ŝ₀=[I_{N} [symbol] (W₀^{H}C₀^{H})]F^{H}\hat{D}₀^{H}\hat{R}ᵣᵣ⁻¹F_{y} (31)

E[ŝŝ^{H}]=[I_{N} [symbol] (W₀^{H}C₀^{H})]F^{H}\hat{D}₀^{H}\check{R}⁻¹\hat{R}ᵣᵣ\check{R}⁻¹\hat{D}₀F[I_{N} [symbol] (C₀W₀)] (32)

Where \hat{R}ᵣᵣ may be the estimated correlation matrix, and \check{R}−1 may be an assumed correlation with estimated parameters. As such, a select signal component for each transmission symbol may have diagonal entries expressed using equation (33).

[I_{N} [symbol] (W₀^{H}C₀^{H})]F^{H}\hat{D}₀^{H}\check{R}⁻¹·D₀F(I_{N} [symbol] C₀W₀)s (33)

Thereafter, select signal power and total power per symbol may be estimated, and accordingly, averaged SINR values per Walsh code may be determined. In another aspect, frame error rate (FER) values may be determined using a similar process as described above.

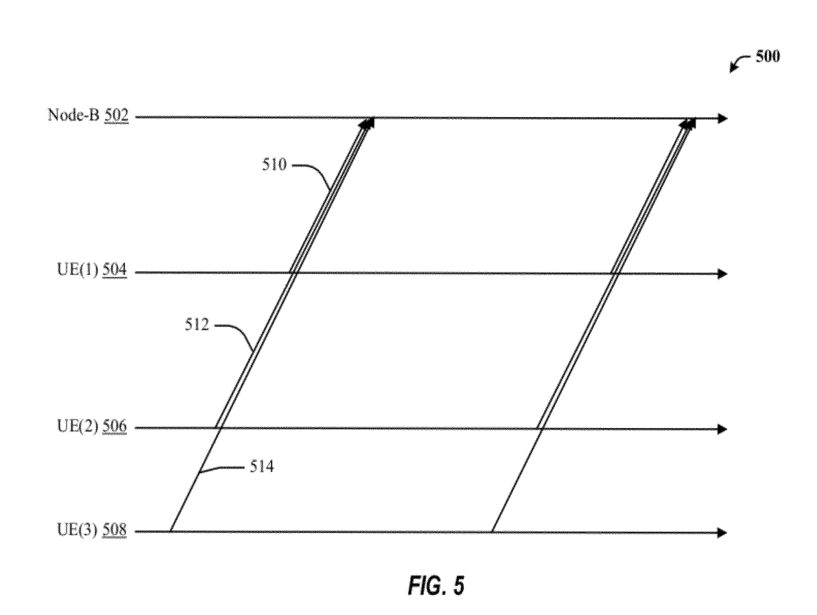

FIG. 5 is a diagram conceptually illustrating an exemplary TD-SCDMA based system 500 with multiple UEs communicating with a node B as time progresses according to one aspect of the present disclosure. Generally, in TD-SCDMA systems, multiple UEs may share a common bandwidth in communication with a node B 502. Additionally, one aspect in TD-SCDMA systems, as compared to CDMA and WCDMA systems, is UL synchronization. That it, in TD-SCDMA systems, different UEs (504, 506, 508) may synchronize on the uplink (UL) such that all UEs (504, 506, 508) transmitted signals arrives at the node B at approximately the same time. For example, in the depicted aspect, various UEs (504, 506, 508) are located at various distances from the serving node B 502. Accordingly, in order for the UL transmission to reach the node B 502 at approximately the same time, each UE may originate transmissions at different times. For example, UE(3) 508 may be farthest from node B 502 and may perform an UL transmission 514 before closer UEs. Additionally, UE 506(2) may be closer to node B 502 than UE(3) 508 and may perform an UL transmission 512 after UE(3) 508. Similarly, UE(1) 504 may be closer to node B 502 than UE(2) 506 and may perform an UL transmission 510 after UE(2) 506 and UE(3) 508. The timing of the UL transmissions (510, 512, 514) may be such that the signals arrive at the node B at approximately the same time.

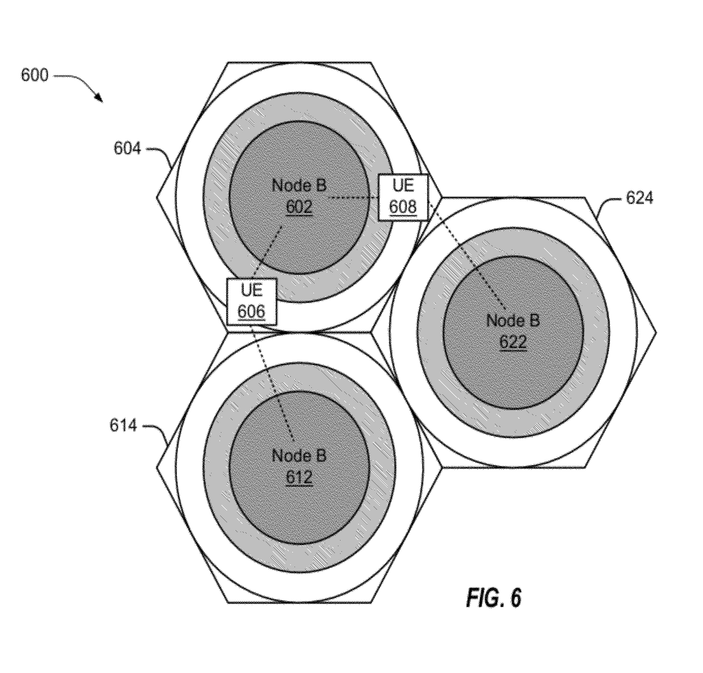

With reference now to FIG. 6, a diagram conceptually illustrating an exemplary wireless communications system 600 is presented. System 600 may include multiple Node Bs (602, 612, 622), where each Node B serves a region (e.g. cell), such as regions 604, 614 and 624 respectively. In one aspect, a serving Node B 602 may service multiple UEs (606, 608). Additionally, a LIE may receive signals from more than one Node B (e.g., UE 606 receives signals from Node Bs 602 and 612). For the UE to be able to process a serving cells 602 signals, interference from other cells (612, 622) may be removed or reduced. In one aspect, UE 606 may include a FDE enabled to efficiently reduce other cell interference.

In one aspect, serving Node B may allocation resources to UEs (606, 608) in such a manner as to attempt to minimize interference with a neighboring cell which is experiencing high load conditions (e.g. 612), and/or maximizing data rates for UEs located where interference with a neighboring cell is not relevant. In one such aspect, a UE may be located near the serving Node B, and as such, neighbor cell interference is not a concern. In another aspect, a UE may be located near a cell 624 served by a Node B 622 which is not experiencing a high load. In such an aspect, the serving Node B may allocate a higher data rate to the UE 608 without concern regarding other cell 624 interference. Operation of such interference processing is depicted in FIG. 4.

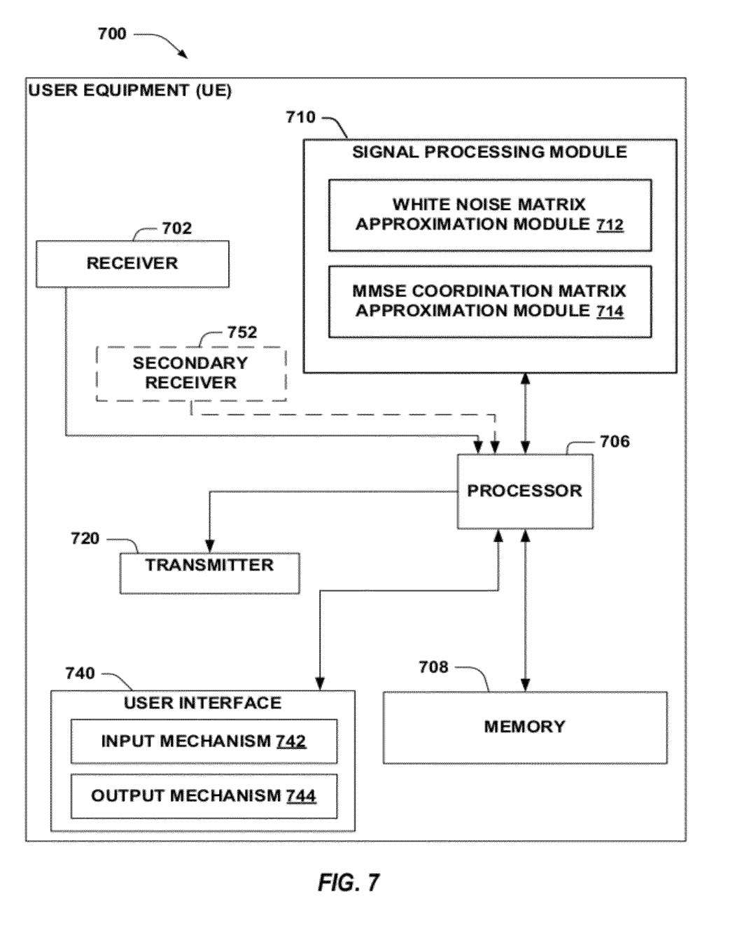

With reference now to FIG. 7, an illustration of a UE 700 (e.g. a client device, wireless communications device (WCD), etc.) that can facilitate efficient interference reduction is presented. UE 700 comprises receiver 702 that receives one or more signal from, for instance, one or more receive antennas (not shown), performs typical actions on (e.g., filters, amplifies, downconverts, etc.) the received signal, and digitizes the conditioned signal to obtain samples. Receiver 702 can further comprise an oscillator that can provide a carrier frequency for demodulation of the received signal and a demodulator that can demodulate received symbols and provide them to processor 706 for channel estimation. In one aspect, UE 700 may further comprise secondary receiver 752 and may receive additional channels of information.

Processor 706 can be a processor dedicated to analyzing information received by receiver 702 and/or generating information for transmission by one or more transmitters 720 (for ease of illustration, only one transmitter is shown), a processor that controls one or more components of UE 700, and/or a processor that both analyzes information received by receiver 702 and/or receiver 752, generates information for transmission by transmitter 720 for transmission on one or more transmitting antennas (not shown), and controls one or more components of UE 700.

UE 700 can additionally comprise memory 708 that is operatively coupled to processor 706 and that can store data to be transmitted, received data, information related to available channels, data associated with analyzed signal and/or interference strength, information related to an assigned channel, power, rate, or the like, and any other suitable information for estimating a channel and communicating via the channel. Memory 708 can additionally store protocols and/or algorithms associated with estimating and/or utilizing a channel (e.g., performance based, capacity based, etc.).

It will be appreciated that the data store (e.g., memory 708) described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable PROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Memory 708 of the subject systems and methods is intended to comprise, without being limited to, these and any other suitable types of memory.

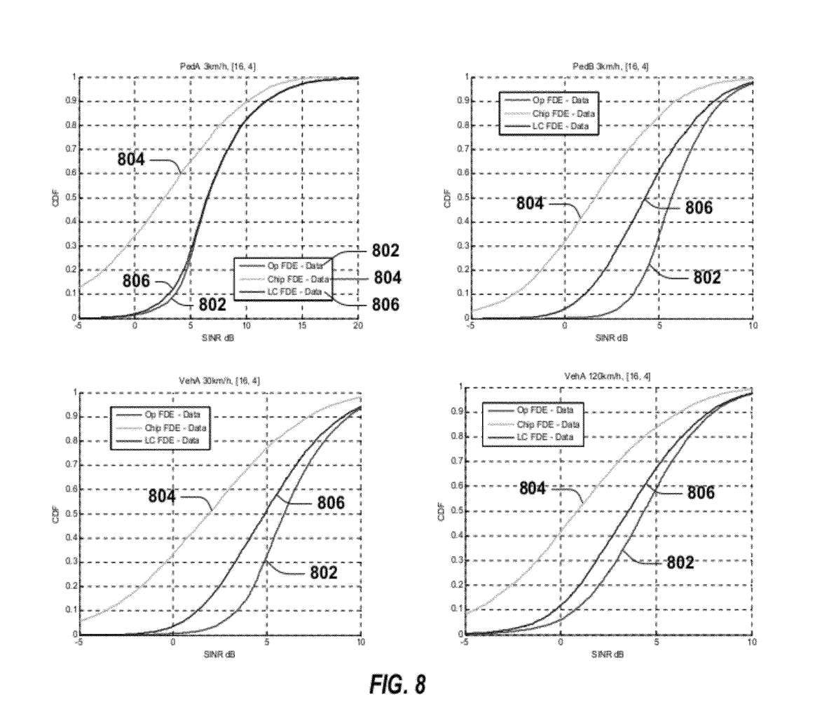

UE 700 can further comprise resource signal processing module 710 which may be operable to process signals received by UE 700. In one aspect, signal processing module 710 may be operable to allow a receiver 702 to exploit both channel frequency selectivity and interfering signals in a Walsh domain structure with low complexity. In one aspect, signal processing module 710 may attain optimal linear MMSE performance where cells in an active set are flat fading and/or white in Walsh domain. In one aspect, signal processing module 710 may include white noise matrix approximation module 712 and MMSE coordination matrix module 714. In one aspect, white noise matrix approximation module 712 is operable substitute an identity matrix for a white noise power gain matrix for a cell. For example, signals with power gain matrices (e.g., G₀, G₁) may be received from two cells, and one of those cells may be determined to have white noise, as described in a Walsh domain. In such an example, white noise matrix approximation module 712 may substitute an identity matrix for the power gain matrix from the white noise cell (e.g., G₀=I or G₁=I). In one aspect, most Walsh codes in a single time slot in TDS-HSDPA DL may be assigned to a single user. In one aspect, if white noise matrix approximation module 712 determines that both cells have colored noise, then white noise matrix approximation module 712 may determine a serving cell may be selected to have white noise, and as such, the power gain matrix for the serving cell may be replaced with an identity matrix. In such an aspect, the 702 receiver may experience some loss of performance due to the approximation. In one aspect, MMSE coordination matrix module 714 may be operable generate an MMSE coordination matrix for using in processing MMSE signals. In one aspect, MMSE coordination matrix module 714 may be operable to invert a MMSE coordination matrix for processing MMSE signals. Operation of such matrix processing is depicted in FIG. 4. Further, FIG. 8 depicts simulation results for various receiver configurations.

Moreover, in one aspect, processor 706 may provide the means for receiving two or more signals from two or more cells, means for determining at least one of the two or more cells does not comprise colored noise, means for applying a white noise matrix approximation to each of the at least one of the two or more cells that does not comprise colored noise, means for applying a channel matrix approximation to the two or more received signals, and means for generating a MMSE coordination matrix using the white noise matrix approximation and the channel matrix approximation.

Additionally, UE 700 may include user interface 740. User interface 740 may include input mechanisms 742 for generating inputs into UE 700, and output mechanism 742 for generating information for consumption by the user of UE 700. For example, input mechanism 742 may include a mechanism such as a key or keyboard, a mouse, a touch-screen display, a microphone, etc. Further, for example, output mechanism 744 may include a display, an audio speaker, a haptic feedback mechanism, a Personal Area Network (PAN) transceiver etc. In the illustrated aspects, output mechanism 744 may include a display operable to present content that is in image or video format or an audio speaker to present content that is in an audio format.

With reference now to FIG. 8, multiple cumulative distribution function (CDF) graphs 800 are illustrated for various receiver configurations. Further, FIG. 8 depicts three receiver designs with different levels of optimality and complexity, where: (Op FDE) 802 is used to denote an optimal receiver design; (chip FDE) 804 is used to denote a conventional chip level equalizer design (e.g., channel frequency domain selectivity); and low complexity (LC FDE) 806 is used to denote a receiver designed using one or more aspects discussed with respect to FIG. 4. Further, the graphs depicted in FIG. 8 are based on an assumed Walsh code combination of (16, 4), and with two cells (a serving cell transmitting at 0 dB, and a non-serving cell transmitting at −3 dB), with various channels. In one aspect, the channels may be described as follows: PedA 3 km/h depicts a relatively flat channel; PedB 3 km/h depicts a frequency selective channel, and various vehicle simulations (e.g., VehA 30 km/h, and VehB 12 km/h). Further, the three designs may be plotted based on estimated SINR values. Still further, analysis of the graphs may indicate that the LC FDE 806 design may not incur much loss for PedA 3 km/h, and loss may include with channel selectivity, as seen for PedB 3 km/h. Additionally, the LC FDE 806 design gets closer to the Op FDE 803 design performance as interfering Walsh domain structures are reduced (e.g., active code from 4, 8, 12 and 16).

As seen in the graphs depicted in FIG. 8, the LC FDE 806 design may provide improved performance over chip FDE 804 designs with minimal complexity increases.

Several aspects of a telecommunications system has been presented with reference to a TD-SCDMA system. As those skilled in the art will readily appreciate, various aspects described throughout this disclosure may be extended to other telecommunication systems, network architectures and communication standards. By way of example, various aspects may be extended to other UMTS systems such as W-CDMA, HSDPA, High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard, employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one” of a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication, comprising:
receiving two or more signals from two or more cells;
determining at least one of the two or more cells does not comprise colored noise;
applying a white noise matrix approximation to each of the at least one of the two or more cells that does not comprise colored noise;
applying a channel matrix approximation to the two or more received signals; and
generating a minimum mean square error (MMSE) coordination matrix using the white noise matrix approximation and the channel matrix approximation.

2. The method of claim 1, further comprising determining one or more MMSE signals by applying the MMSE coordination matrix to the received two or more signals.

3. The method of claim 2, wherein the determining further comprises:
determining an inverse coordination matrix by inverting the MMSE coordination matrix; and
applying the inverse coordination matrix to the received two or more signals.

4. The method of claim 3, wherein the determining the inverse coordination matrix further comprises inverting the MMSE coordination matrix using iterative processing.

5. The method of claim 1, wherein each signal is communicated over one or more channels, where each channel is described using a channel vector and a spreading vector, and where each signal includes one or more data blocks each including a number of symbols.

6. The method of claim 1, wherein the two or more signals are either known from previous sampling or approximated.

7. The method of claim 1, wherein the determining further comprises:
determining that all of the two or more cells comprise colored noise; and
indicating a serving cell of the two or more cells does not comprise colored noise.

8. The method of claim 1, wherein applying the white noise matrix approximation further comprises substituting an identity matrix for a power gain matrix for each of the at least one of the two or more cells that does not comprise colored noise.

9. The method of claim 1, wherein the channel matrix (D) approximation is described by the expression D²=D₀D₀^{H}+D₁D₁^{H}+σ²I.

10. The method of claim 1, wherein the MMSE coordination matrix (\tilde{R}ᵣᵣ) is described by the expression
$${\check{R}}_{rr} = DF \{ \frac{tr ( {D}_{0} {D}_{0}^{H} )}{tr ( {D}^{2} )} I + \frac{tr ( {D}_{1} {D}_{1}^{H} )}{tr ( {D}^{2} )} B + \frac{tr ( {σ}^{2} I )}{tr ( {D}^{2} )} I \} {F}^{H} {D}^{H} .$$

11. An apparatus for wireless communication, comprising:
means for receiving two or more signals from two or more cells;
means for determining at least one of the two or more cells does not comprise colored noise;
means for applying a white noise matrix approximation to each of the at least one of the two or more cells that does not comprise colored noise;
means for applying a channel matrix approximation to the two or more received signals; and means for generating a MMSE coordination matrix using the white noise matrix approximation and the channel matrix approximation.

12. The apparatus of claim 11, further comprising means for determining one or more MMSE signals by applying the MMSE coordination matrix to the received two or more signals.

13. The apparatus of claim 12, wherein the means for determining further comprises:
means for determining an inverse coordination matrix by inverting the MMSE coordination matrix; and
means for applying the inverse coordination matrix to the received two or more signals.

14. The apparatus of claim 13, wherein the means for determining the inverse coordination matrix further comprises means for inverting the MMSE coordination matrix using iterative processing.

15. The apparatus of claim 11, wherein each signal is communicated over one or more channels, where each channel is described using a channel vector and a spreading vector, and where each signal includes one or more data blocks each including a number of symbols.

16. The apparatus of claim 11, wherein the two or more signals are either known from previous sampling or approximated.

17. The apparatus of claim 11, wherein the means for determining further comprises:
means for determining that all of the two or more cells comprise colored noise; and
means for indicating a serving cell of the two or more cells does not comprise colored noise.

18. The apparatus of claim 11, wherein the means for applying the white noise matrix approximation further comprises means for substituting an identity matrix for a power gain matrix for each of the at least one of the two or more cells that does not comprise colored noise.

19. The apparatus of claim 11, wherein the channel matrix (D) approximation is described by the expression D²=D₀D₀^{H}+D₁D₁^{H}+σ²I.

20. The apparatus of claim 11, wherein the MMSE coordination matrix (\tilde{R}ᵣᵣ) is described by the expression
$${\check{R}}_{rr} = DF \{ \frac{tr ( {D}_{0} {D}_{0}^{H} )}{tr ( {D}^{2} )} I + \frac{tr ( {D}_{1} {D}_{1}^{H} )}{tr ( {D}^{2} )} B + \frac{tr ( {σ}^{2} I )}{tr ( {D}^{2} )} I \} {F}^{H} {D}^{H} .$$

21. A computer program product, comprising:
a computer-readable medium comprising code for:
receiving two or more signals from two or more cells;
determining at least one of the two or more cells does not comprise colored noise;
applying a white noise matrix approximation to each of the at least one of the two or more cells that does not comprise colored noise;
applying a channel matrix approximation to the two or more received signals; and
generating a minimum mean square error (MMSE) coordination matrix using the white noise matrix approximation and the channel matrix approximation.

22. The computer program product of claim 21, wherein the computer-readable medium further comprises code for:
determining one or more MMSE signals by applying the MMSE coordination matrix to the received two or more signals.

23. The computer program product of claim 22, wherein the computer-readable medium further comprises code for:
determining an inverse coordination matrix by inverting the MMSE coordination matrix; and
applying the inverse coordination matrix to the received two or more signals.

24. The computer program product of claim 23, wherein the computer-readable medium further comprises code for inverting the MMSE coordination matrix using iterative processing.

25. The computer program product of claim 21, wherein each signal is communicated over one or more channels, where each channel is described using a channel vector and a spreading vector, and where each signal includes one or more data blocks each including a number of symbols.

26. The computer program product of claim 21, wherein the two or more signals are either known from previous sampling or approximated.

27. The computer program product of claim 21, wherein the computer-readable medium further comprises code for:
determining that all of the two or more cells comprise colored noise; and
indicating a serving cell of the two or more cells does not comprise colored noise.

28. The computer program product of claim 21, wherein the computer-readable medium further comprises code for applying the white noise matrix approximation further comprises substituting an identity matrix for a power gain matrix for each of the at least one of the two or more cells that does not comprise colored noise.

29. The computer program product of claim 25, wherein the channel matrix (D) approximation is described by the expression D²=D₀D₀^{H}+D₁D₁^{H}+σ²I.

30. The computer program product of claim 26, wherein the MMSE coordination matrix (\tilde{R}ᵣᵣ) is described by the expression
$${\check{R}}_{rr} = DF \{ \frac{tr ( {D}_{0} {D}_{0}^{H} )}{tr ( {D}^{2} )} I + \frac{tr ( {D}_{1} {D}_{1}^{H} )}{tr ( {D}^{2} )} B + \frac{tr ( {σ}^{2} I )}{tr ( {D}^{2} )} I \} {F}^{H} {D}^{H} .$$

31. An apparatus for wireless communication, comprising:
at least one processor; and
a memory coupled to the at least one processor,
a receiver configured to receive two or more signals from two or more cells;
wherein the at least one processor is configured to:
determine at least one of the two or more cells does not comprise colored noise;
apply a white noise matrix approximation to each of the at least one of the two or more cells that does not comprise colored noise;
apply a channel matrix approximation to the two or more received signals; and
generate a MMSE coordination matrix using the white noise matrix approximation and the channel matrix approximation.

32. The apparatus of claim 31, wherein the processor is further configured to:
determine one or more MMSE signals by applying the MMSE coordination matrix to the received two or more signals.

33. The apparatus of claim 32, wherein the processor is further configured to:
determine an inverse coordination matrix by inverting the MMSE coordination matrix; and
apply the inverse coordination matrix to the received two or more signals.

34. The apparatus of claim 33, wherein the processor is further configured to:
invert the MMSE coordination matrix using iterative processing.

35. The apparatus of claim 31, wherein each signal is communicated over one or more channels, where each channel is described using a channel vector and a spreading vector, and where each signal includes one or more data blocks each including a number of symbols.

36. The apparatus of claim 31, wherein the two or more signals are either known from previous sampling or approximated.

37. The apparatus of claim 31, wherein the processor is further configured to:
determine that all of the two or more cells comprise colored noise; and
indicate a serving cell of the two or more cells does not comprise colored noise.

38. The apparatus of claim 31, wherein the processor is further configured to substitute an identity matrix for a power gain matrix for each of the at least one of the two or more cells that does not comprise colored noise

39. The apparatus of claim 31, wherein the channel matrix (D) approximation is described by the expression D²=D₀D₀^{H}+D₁D₁^{H}+σ²I.

40. The apparatus of claim 31, wherein the MMSE coordination matrix (\tilde{R}ᵣᵣ) is described by the expression
$${\check{R}}_{rr} = DF \{ \frac{tr ( {D}_{0} {D}_{0}^{H} )}{tr ( {D}^{2} )} I + \frac{tr ( {D}_{1} {D}_{1}^{H} )}{tr ( {D}^{2} )} B + \frac{tr ( {σ}^{2} I )}{tr ( {D}^{2} )} I \} {F}^{H} {D}^{H} .$$
